(19) United States
(12) Patent Application Publication
(10) Pub. No.: US 2009/0257816 A1
(43) Pub. Date: Oct. 15, 2009

(54) ERASABLE INK FOR POROUS TIP WRITING INSTRUMENTS

(76) Inventors: Pawel CZUBAROW, Wellesley, MA (US); Joshua Hart POLLACK, King City (CA); Jeremy Matthew SCHWARTZ, Eden Prairie, MN (US)

Correspondence Address: LADAS & PARRY LLP, 224 SOUTH MICHIGAN AVENUE, SUITE 1600, CHICAGO, IL, 60604, US

(21) Appl. No.: 12/103,461

(22) Filed: Apr. 15, 2008

(51) Int. Cl. B43K 8/06; C09D 11/16

(52) U.S. Cl. 401/198; 106/31.6; 523/161; 106/31.9

(57) ABSTRACT

Disclosed herein is a water-based erasable ink for use in a writing instrument. The ink comprises platy-like pigment particles, film formers and an aqueous vehicle. Also disclosed are writing instruments using such inks as well as comprising a reservoir containing a water based erasable ink having a non-shear-thinning composition and a porous fiber nib in fluid communication with this reservoir. Related methods of forming an erasable marking are also disclosed.

### FIELD OF THE INVENTION

The invention generally relates to erasable inks, and more particularly, but not exclusively, to erasable inks for use in writing instruments such as porous nib markers.

### BACKGROUND OF THE INVENTION

Some writing instruments such as markers, include erasable inks which allow markings formed with the ink to be erased.

### SUMMARY OF THE INVENTION

In accordance with an aspect of the invention there provided a water-based erasable ink for use in a writing instrument comprising: platy-like pigment particles; film formers; and an aqueous vehicle.

In accordance with another aspect of the invention, there is provided a writing instrument comprising: a reservoir containing a water based erasable ink comprising platy-like pigment particles and film formers dispersed in an aqueous vehicle.

In accordance with a further aspect of the invention there is provided a writing instrument comprising: a reservoir containing a water based erasable ink having a non-shear-thinning composition and a porous fiber nib in fluid communication with the reservoir.

In accordance with yet another aspect of the invention there is provided a method of forming an erasable marking on a paper substrate comprising: making a marking on the substrate with a writing instrument containing a water based erasable ink comprising platy-like pigment particles and film formers dispersed in an aqueous vehicle.

In accordance with yet a further aspect of the invention, there is provided a method of forming an erasable marking on a paper substrate comprising: making a marking on the paper substrate with a writing instrument containing a water based erasable ink having a non-shear-thinning composition, and having a porous fiber nib for delivering the ink to the paper substrate.

In accordance with one aspect of the invention, there is provided an erasable ink for use in a writing instrument comprising an aqueous vehicle and a pigment having a platy-like morphology. In an embodiment, the pigment is dispersed in the aqueous vehicle, and the ink is substantially free of colorants other than the pigment.

In accordance with another aspect of the invention, there is provided an erasable ink for use in a writing instrument comprising an aqueous vehicle and a platy-like pigment. In an embodiment, the pigment has an average diameter from about 1 micron to about 75 microns, and is dispersed in the aqueous vehicle.

In accordance with an additional aspect of the invention, there is provided a method of forming an erasable marking on a paper substrate comprising making a marking on the substrate with a writing instrument containing an erasable ink. In an embodiment, the erasable ink comprises a aqueous vehicle and a pigment having a platy-like morphology. In an embodiment, the pigment is dispersed in the aqueous vehicle, and the ink is substantially free of colorants other than the pigment.

In accordance with yet another aspect of the invention, there is provided a method of forming an erasable marking on a paper substrate comprising making a marking on the substrate with a writing instrument containing an erasable ink. In an embodiment, the erasable ink comprises a aqueous vehicle and a platy-like pigment. In an embodiment, the pigment has an average diameter from about 1 micron to about 75 microns, and is dispersed in the aqueous vehicle.

In accordance with yet another aspect of the invention, there is provided a writing instrument comprising a reservoir containing an erasable ink. In an embodiment, the erasable ink comprises a aqueous vehicle and a pigment having a platy-like morphology. In an embodiment, the pigment is dispersed in the aqueous vehicle, and the ink is substantially free of colorants other than the pigment.

In accordance with another aspect of the invention, there is provided a writing instrument comprising a reservoir containing an erasable ink. In an embodiment, the erasable ink comprises an aqueous vehicle and a platy-like pigment. In an embodiment, the pigment has an average diameter from about 1 micron to about 75 microns, and is dispersed in the aqueous vehicle.

This invention provides erasable inks that provide good writing performance when used in writing instruments such as fiber-porous nib markers. It is desirable that erasable inks be easily erased using a conventional eraser, that erasure be substantially complete, and that it be possible to erase the marking both immediately after the marking is made and after a period of time has elapsed. It is also desirable that erasable inks provide good writing performance in terms of smoothness and laydown when compared with non-erasable inks. The present invention seeks to meet these and other objects

These and other features, aspects, and advantages of the invention will become better understood with regard to the following description and appended claims.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a perspective view of a writing instrument according to an embodiment of the invention;

FIG. 2 is a cross-sectional view of the writing instrument shown in FIG. 1; and

FIG. 3 is a cross-sectional lateral view of a writing instrument according to an alternative embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF ILLUSTRATIVE EMBODIMENTS

Before describing in detail embodiments that are in accordance with the present invention, it should be observed that the embodiments reside primarily in combinations of method steps and apparatus components related to erasable inks. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Generally stated, the invention provides erasable inks for use in writing instruments. In an embodiment, erasability can be obtained by using pigments having a platy-like morphology as the colorant in the ink. In certain non-limiting embodiments, such pigments are the only colorant in the ink, i.e., the ink is substantially free of dyes, and of pigments having a non-platy-like morphology, as these colorants will tend to interfere with erasability.

In other embodiments, the inks are non-shear-thinning, i.e., the inks are Newtonian liquids.

In one embodiment, the invention features an erasable ink for use in a writing instrument including a aqueous vehicle, and, dispersed in the aqueous vehicle as a colorant, a pigment having a platy-like morphology, the ink being substantially free of other colorants.

Implementations of the above embodiment, may include one or more of the following features. The pigment is a pearlescent pigment. The pigment is selected from the group consisting of mica platy pigments, graphites, and metal platy pigments. According to certain embodiments, the ink exhibits an erasability of at least 80%. The aqueous vehicle system is comprised of water and humectants. The ink is non-shear-thinning.

Implementations of this aspect of the invention may include one or more of the following features. The pigment is a pearlescent pigment. The pigment is selected from the group consisting of mica platy pigments, graphites, and metal platy pigments. system. The ink is non-shear-thinning.

In an embodiment, the invention features an erasable ink for use in a writing instrument, including an aqueous vehicle and, dispersed in the aqueous vehicle as a colorant, a pigment having an Inposelstartaverage aspect ratiolnposelend of from about 1:1 to about 8:8.

Implementations of this embodiment, may include one or more of the following features. The pigment is a pearlescent pigment. The pigment is selected from the group consisting of mica platy pigments, graphites, and metal platy pigments. The ink exhibits an erasability of at least 80%. The aqueous vehicle is comprised of water and humectants. The ink is non-shear-thinning.

When used in a writing instrument, the inks of the invention exhibit even laydown and good line intensity, e.g., a line intensity greater than about 25 percent according to one non-limiting example, or greater than about 30 percent according to another non-limiting example, good line uniformity, and good writing performance.

The term “laydown” refers to the amount of ink that is deposited on a substrate when making a marking of a particular length. Embodiments of the invention exhibit laydown for pearlescent inks is between about 0.1 mg/m and about 15.0 mg/m; or between about 1.0 mg/m and about 12.0 mg/m; or between about 5.0 mg/m and about 10.0 mg/m, to give but three example.

As used herein, the term “even laydown” refers to, the morphology of the ink when it is intended to be applied to a substrate to create a continuous marking and is characterized by minimal skipping, i.e., few voids within the written line, and uniform thickness, i.e., the width of the written line is approximately constant along the length of the line.

As used herein, the term “line intensity” refers to the intensity of a marking made on a substrate such as paper. The intensity of a marking can be measured as the average gray value of the detected tracings (e.g., with black=0; white=255 on a scale of zero to 255). The percent intensity of the writing with an average gray value of z is then calculated as: % Intensity=(1−[z/255]) multiplied by 100. Alternatively, the intensity of a marking can be determined by calculating the difference between the recorded reflectance of the substrate without any marking (“Blank Reflectance”) and the reflectance of the marking on the substrate (“Reflectance of Marking”). According to this method, the percent intensity of a marking is calculated by normalizing the calculated intensity difference to the Blank Reflectance and multiplying this value by 100. A black standard has an intensity of marking equal to 100%. The data obtained from these two methods are comparable.

As used herein, the term “line uniformity” refers to, without limitation, the standard deviation of the line intensity measured along different portions of a marking made on a substrate. Line uniformity can be used as a measure of even laydown.

In an embodiment, the erasable inks include a platy-like pigment dispersed in an aqueous vehicle system.

The inks include from about 1 weight percent to about 50 weight percent of the platy-like pigment in accordance with an embodiment of the invention, and from about 30 weight percent to about 99 weight percent of the aqueous vehicle. In accordance with another embodiment, the inks include from about from about 3 weight percent to about 25 weight percent of the platy-like pigment, and from about 60 weight percent to about 96 weight percent of the aqueous vehicle. In accordance with a further embodiment, the inks include from about 5 weight percent to about 20 weight percent of the platy-like pigment, and from about 74 weight percent to about 94 weight percent of the aqueous vehicle.

In an embodiment, the erasable inks exhibit an erasability greater than about 80 percent. In another embodiment, the erasable inks exhibit a line intensity greater than about 30 percent. In a further embodiment, the erasable inks exhibit a line intensity greater than about 40 percent

### Platy-Like Pigments:

The average dimensions of the pigment particles can be ascertained by performing scanning electron microscopy (SEM). In an embodiment, pigments typically have an average thickness of less than about 3 microns; in another embodiment, the pigments have an average thickness of less than about 1 micron; in a further embodiment, the pigments have an average thickness of less than about 0.5 microns; and, in accordance with yet another embodiment, the pigments have an average thickness of less than about 0.25 micron. Further, in accordance with an embodiment, the pigments have an average thickness from about 0.1 micron to 1 micron. In an embodiment, the pigments have an average diameter of from about 1 micron to about 75 microns.

The dimensions of the pigment particles can also be described by an aspect ratio of the length to the width. The average length and average width can be the same or different. The average width of the pigment particles is less than the average length for example. An average aspect ratio of the length to the width, typically, is between about 1:1 and about 8:1; alternatively, between about 1:1 and about 5:1; in another example, between about 1:1 and about 3:1; and in another embodiment, between about 1:1 and about 2:1.

In general, the largest dimension of the pigment particles is limited by the need for the pigment particles to pass through the point openings In writing instruments and by the requirement that the pigment particles form stable suspensions that do not settle over time. The smallest dimension of the pigment particles is selected to limit penetration of the particles into the interstices of the substrate material. The platy-like morphology of the pigment particles results in a “leafing” phenomenon wherein the particles lie flat and align horizontally on the surface of the substrate material, overlapping each other, without penetrating into the interstices of the substrate. Such leafing particles are easily erased, whereas particles in the interstices generally are not.

Suitable pigments include mica flake pigments, metal oxide-coated mica-based pearlescent pigments, other types of platy-like pearlescent pigments, graphites having a platy-like morphology, glass platy pigments, and metal platy pigments.

Suitable mica platy pigments include, for example, Mica Black (iron oxide, titanium dioxide/mica), Micronasphere M (silica/mica), Colorona Blackstar Blue (iron oxide/mica), Microna Matte Blue (ferric ferrocyanide/mica), and Afflair 110 (titanium dioxide/mica), available from EMD Chemicals, Inc., An Affiliate of Merck KGaA. Darmstadt, Germany

Suitable metal oxide-coated micas, also referred to as “nacreous” pigments, are described in, e.g., U.S. Pat. No. 3,087,828, the disclosure of which is incorporated herein by reference. A suitable mica phase for use in such pigments is Illite (JCPDS card #26-0911). Suitable metal oxides for use in nacreous pigments include titanium dioxide, chromium oxide, cobalt oxide, nickel oxide, tin oxide and iron oxide. A suitable iron oxide is hematite. Nacreous pigments which provide a pearlescent effect, referred to herein as “pearlescent pigments” are commercially available. Preferred pearlescent pigments include products sold under the trade names Afflair (EMD Chemicals, Inc., Hawthorne, N.Y.); Timiron, Colorona, Soloron, Dichrona, and Biron (the Rona division of EM Industries, Inc., Hawthorne, N.Y.); Mearlin, Cellini, Timica, Duocrome, and Mearlite (Engelhard Corporation, Iselin, N.J.); Flonac (Presperse, Inc., Piscataway, N.J.); and Firemax (Rocky Mountain International, Denver, Colo.).

Other suitable pearlescent pigments, referred to as combination pigments, are created by precipitating a coating of other pigments or dyes on top of or simultaneously with the original oxide layer. Examples of these materials include iron oxide (Fe₂O₃ or Fe₃O₄), chromic oxide (Cr₂O₃), cobalt titanate (CoTiO₃), aluminum oxide, silica, ferric ferrocyanide, iron blue, carmine, and D&C Red 30. Combination pigments produce colors which are a mixture of both interference and absorption effects. When the absorption color (arising from the mass tone of the inorganic or organic colorant) is the same as the interference color, the resulting pearlescent pigment has a rich, brilliant color. When the absorption color is different from the interference color, the resulting pigment has a dual-color, or two-tone, effect. In this situation, the color observed varies according to the viewing angle, with the interference color being seen at the specular angle and the absorption color being seen at all other angles. These pigments are referred to as “dichromatic pigments.” Such pigments are commercially available from the Rona division of EMD Chemicals Inc. under the trade names Dichrona and Colorona. Various non-neutral colors can be obtain. Non-neutral refers to colors that are not black or white or on the continuum of gray shades between black and white.

Two or more pearlescent pigments of different or the same colors can be mixed to obtain desired color effects. If the pigments derive color from interference alone, then the colors mix additively, e.g., blue and yellow does not yield green, but instead yields white or a lighter blue or yellow, depending on the ratio of blue to yellow pigment. Thus, if a blue interference pigment is a more intense blue than desired, a yellow interference pigment can be added to adjust the color. Combining a blue interference pigment with a second blue pigment that derives color from both interference and absorption can result in a mixture that is brilliant blue.

Pearlescent pigments can also be mixed with non-pearlescent pigments. In most cases, the color that will result is determined empirically. However, in the case of mixing pearlescent pigments with a black pigment, e.g., black Mica pigment composed of mica, titanium dioxide, and black iron oxide, the color results can be predicted.

For example, if the pearlescent pigment is a violet interference pigment which is mixed with the black, the color is perceived as becoming more intensely violet as the black absorbs scattered light. If the pearlescent pigment is a two-tone pigment which is mixed with the black, the color is perceived as changing from a two-tone effect (with the absorption pigment the predominant color) to a color dominated by the interference color as the black absorbs the scattered light from the absorption pigment. For a red/blue pearlescent pigment (carmine with a titanium dioxide layer), the perceived color changes from a purplish pink to an intense bluish purple as the black is added. Similarly, if the pearlescent pigment has an oxide layer that produces both an interference color and an absorption color, addition of a black pigment causes the mixture to change to a color dominated by the interference color. Addition of black to a red pearlescent pigment (red iron oxide layer) is perceived as changing color from brownish red to reddish purple. Additional examples of suitable color combinations are disclosed in commonly assigned co-pending application U.S. Ser. No. 09/609,811, entitled “Pearlescent Inks,” and also, in a continuation-in-part application of U.S. Ser. No. 09/609,811, entitled “Pearlescent Inks, Writing Instruments, and Methods,” the disclosures of which are incorporated herein by reference.

Suitable non-mica-based pearlescent pigments include natural pearl essence (guanine/hypoxanthine crystals from fish scales), basic lead carbonate, lead hydrogen arsenate, and bismuth oxychloride pigments. Suitable bismuth oxychloride platys include, for example, Biron ESQ and Biron LF-2000, also available from EMD Chemicals, Inc.

Suitable graphite particles include, but are not limited to, amorphous graphite, platy natural graphite, primary synthetic graphite, and secondary synthetic graphite. Primary and secondary synthetic graphite particles are synthetically produced and purified particles, whereas amorphous and platy graphite particles are naturally occurring. In an embodiment, the graphite particles are platy natural graphite. Examples of suitable graphite particles include, but are not limited to, those sold under the trade names, Micro750 and Micro790 (platy), Micro150 and Micro 190, 505, 508(amorphous), Micro250 and Micro290 (primary synthetic), and Micro450 and Micro490 (secondary synthetic), available from Graphite Mills, Inc. (Asbury Graphite Mills, N.J.)

Suitable metal platy pigments are described, e.g., in U.S. Pat. Nos. 5,762,694, 5,474,603, and GB Patent No. 974,123, the disclosures of which are incorporated herein by reference. Suitable aluminum platys include, for example, Metalure, Alucolor (organic pigment/aluminum), and Aloxal (aluminum with oxidized surface), available from Eckart America, L.P., Painesville, Ohio. Metal-coated glass platy pigments may also successfully be used in the inks according to the invention.

In an embodiment, the inks be substantially free of colorants that lack the platy-like morphology described above, e.g., pigments that have non-platy-like morphologies and dyes. Such colorants will tend to stain (in the case of dyes) or become entrapped by (in the case of pigments) paper substrates, and thus may deleteriously affect erasability. By “substantially free”, it is meant that the inks do not contain an amount of such colorants that would deleteriously affect erasability. In general, the inks contain less than 0.1 percent by weight of such colorants.

### Aqueous Vehicle:

The aqueous vehicle of the erasable ink is a polar aqueous vehicle system in which water is the primary aqueous vehicle. The aqueous vehicle can consist of water alone, but other water-soluble organic humectants which are useful in inhibiting drying in the point of the writing instrument and in preventing the ink from freezing at low temperatures can be included in the aqueous vehicle system. Examples of humectants that can be used include glycols, glycerol and long chain alcohols. Typically, the erasable ink includes from 1 percent by weight to 40 percent by weight of humectants. Alternatively, the erasable ink includes 5 percent by weight to 30 percent by weight of humectants. Alternatively, the erasable ink includes about 8 percent by weight to 25 percent by weight of humectants. If too much humectants is added to the erasable ink, the written marks take longer to dry, have worse erasability, exhibit poorer writing characteristics (uneven line intensity).

### Dispersants:

Additionally, the density and the size of the pigment particles in the erasable writing composition necessitate the use of one or more effective dispersants to disperse the particles into the ink. Typically, such dispersants are water-soluble surfactant polymers that include polymeric chains having “anchoring groups” which may or may not carry a charge, and which are attracted to the pigment and/or pigment particulate surface. When the unbound portion of the polymeric chain is well solvated, it helps to stabilize the dispersion of particles in the aqueous vehicle system

Dispersants are also used to reduce the drying times of the erasable, shear-thinning composition. Typically, the erasable ink includes about 0.01 percent by weight and 5 percent by weight of one or more suitable dispersants; in another embodiment, between about 0.02 percent by weight and 4 percent by weight of one or more dispersants; and alternatively, between about 0.05 percent by weight and 2 percent by weight of one or more dispersants. Compositions not containing sufficient amounts of one or more dispersants may show poor writing performance (reduced or no flow from the point), and may exhibit poor stability with time and/or elevated temperature.

Examples of suitable dispersants include, but are not limited to, nonionic copolymers such as Disperbyk-192 (BYK-Chemie USA, Wallingford, Conn.), anionic copolymers such as Disperbyk-190 and Disperbyk-191 (BYK-Chemie USA, Wallingford, Conn.), anionic phosphated alkoxylated polymers such as Solsperse 40000 and Solsperse 41090 (Avecia Pigments & Additives, Charlotte, N.C.), anionic dimethicone copolyol phosphates such as Pecosil PS-100 and Pecosil PS-150 (Phoenix Chemical, Inc., Somerville, N.J.) and other polymers such as Zephrym PD2434, Zephrym PD2630, Zephrym PD2678, and Zephrym PD3076, available from Uniquema, Wilmington, Del.

### Wetting Agents:

In order to produce a consistent written line, the formulation must readily wet the porous nib of the writing instrument. Furthermore, the formulation must also wet the paper so that written marks dry fast by absorption of the aqueous vehicle into the paper. In an embodiment, wetting agents can be either anionic or nonionic. Typically, the erasable ink includes about 0.01 percent by weight to about 5 percent by weight of one or more suitable wetting agents; alternatively, the erasable ink includes about 0.02 percent by weight to about 4 percent by weight of one or more wetting agents; and in another embodiment, the erasable ink includes between about 0.05 percent by weight and about 2 percent by weight of one or more wetting agents.

Examples of suitable wetting agents include, but are not limited to, anionic phosphate esters such as Ethfac 324 and Ethfac 361 (Ethox Chemical, LLC, Greenville, S.C.), anionic sulfosuccinates such as Emcol 4100M (Witco Corporation, Greenwich, Conn.) and Triton GR-5M (Union Carbide Corporation, Danbury, Conn.), nonionic ethoxylated fatty acids such as Emerest 2634 and Emerest 2646 (Cognis Corporation, Cincinnati, Ohio), nonionic ethoxylated alcohols such as Brij 58, Brij 98, Renex 20, Renex 36 and Synthrapol KB (Uniquema, Wilmington, Del.), and nonionic polyether-modified polydimethylsiloxanes such as BYK-345, BYK-348, BYK-307 and BYX-333 (BYK-Chemie USA, Wallingford, Conn.).

### Preservatives:

One or more anti-microbial preservatives can be added to prevent the growth of bacteria and fungi. In accordance with one example, the agent is a broad-spectrum biocide, 1,2,-benzisothiazolin-3-one, sold as a solution or dispersion under the trade name Proxel. Examples of suitable preservatives include, but are not limited to, Proxel GXL, Proxel BD20, and Proxel XL2 (Avecia Biocides, Wilmington, Del.) In accordance with an embodiment, the erasable inks according to the invention can include 0.01 percent by weight to 0.05 percent by weight of the active ingredient in the preservative product. Other preservatives include, but are not limited to, potassium sorbate, sodium benzoate, pentachlorophenyl sodium, and sodium dehydroacetate.

### Film Formers:

Film formers are additives such as polystyrene-acrylic copolymers sold under Joncryl brand name and produced by BASF for example. Their function is to make the deposited markings more uniform in laydown as well as to bind together the pigment particles. Other film forming additive would be mono or di-saccharides such as glucose or sucrose. In general, addition of film formers reduces smudging and enhances erasability.

### Lubricating Agent:

Lubricating agents are fine particles of PTFE (powdered PTFE) suspended in the vehicle. The role of a lubricating agent is to improve the flow of pigment through the porous nib. One example of such lubricating agent is Microslip 519 manufactured by Presperse, Inc., Piscataway, N.J. Alternatively the lubricating agent comprises aromatic polyesters.

### Other Additives:

The erasable inks according to the invention can also include other additives that are well-known in the art, such as defoamers and corrosion inhibitors.

Additionally, the pH of the composition can be adjusted to increase the stability and writing characteristics of the writing composition. For example, the stability of erasable inks may be enhanced by adjusting the pH of the composition to between about 5 and about 9, e.g., by adding an acid or a base. Alternatively, the pH of the erasable writing composition is between about 7 and about 9 and, in another non-restrictive example, the pH of the erasable ink is between about 7 and about 8.

### Writing Instruments:

Suitable writing instruments to deliver the erasable writing compositions include, but are not limited to, conventional porous nib markers. The nib is in direct contact with a fluid reservoir containing the writing composition or with a valve separating the said nib and the reservoir. The porosity of the nib must be of sufficient size to allow the pigment particles of the erasable inks according to the invention to pass through the pores. In one embodiment, the pore size is at least about 100 microns; and in another embodiment, at least about 25 microns. In one non-limiting example, the nib is made from a group of materials which includes extruded polyester or acrylic fiber filaments which are arranged parallel to each other in the direction of ink flow.

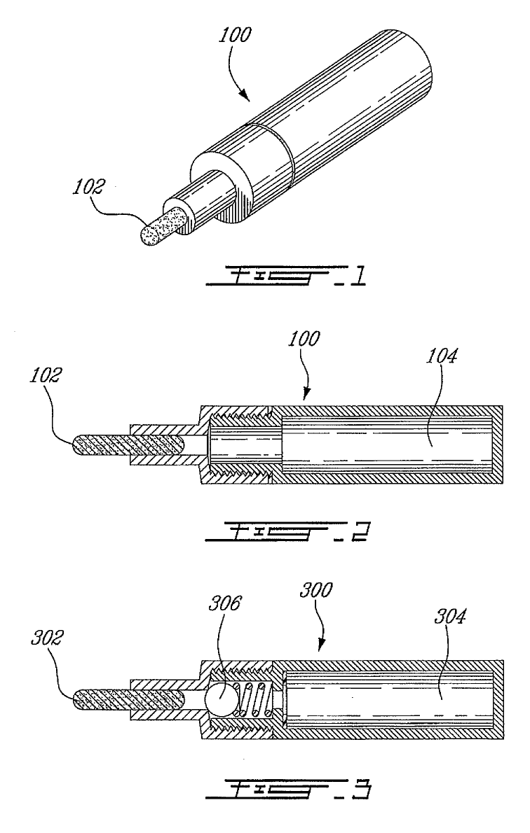

FIG. 1. is a perspective view of a writing instrument 100 having a porous nib 102 according to an embodiment of the invention and FIG. 2. is a cross-sectional view of the writing instrument 100 shown in FIG. 1. As shown in FIG. 2 the porous nib, 102, is in direct communication with an ink reservoir 104. According to certain embodiments the nib comprises fiber bundles aligned in an ink flow direction. The fibers may for example comprise acrylic, or polyester fibers. The fibers are preferably aligned parallel to the longitudinal axis of the nib and the ink will flow in the longitudinal direction. Alternatively, the nib comprises a sponge like material.

FIG. 3. is a crossectional view of a writing instrument 300 according to another embodiment of the invention. In the writing instrument 300 shown in FIG. 3 a porous nib 302 is in fluid communication with an ink reservoir 304 through a valve 306. Writing pressure on the nib 302 actuates the valve 306 allowing ink in the reservoir 304 to flow into the nib 302.

### Methods of Measuring Writing Performance:

The erasability of the erasable inks can be evaluated by manual erasure and visual observation, but this involves personal factors such as applied pressure and size of surface being erased. A more accurate evaluation can be conducted by applying the trace to the substrate via a standard writing test method in which the paper is advanced beneath a writing instrument at a rate of 245 mm per minute. The paper is removed and placed on an erasing instrument including an erasing head provided with a Sanford (Bellwood, Ill.) Pink Pearl pencil eraser #101 (Shore A34 hardness, ASTM D 2240). The erasing head is applied under a load of 380 grams to the paper bearing the trace. The eraser has a surface measuring 7 mm by 3 mm. The erasing head reciprocates at a rate of 75 cycles per minute, the length of each stroke being 50 mm. Each trace is subjected to 25 cycles of erasing which can be visually observed or rated by photometer readings. Once a trace has been applied to the substrate with the writing instrument, the applied trace is left to air dry at room temperature for about five minutes prior to erasing the trace with the erasing head. The photometer readings can be recorded on a reflectometer such as a MacBeth PCM II reflectometer.

The erasability (Eₜₒₜ) can be determined by recording the reflectance of each erased line (“Reflectance of Erased Line”) and the reflectance of the paper without any marking (“Blank Reflectance”) and calculating the ratio of Reflectance of Erased Line to Blank Reflectance, i.e., Eₜₒₜ-(Erased Line/Blank). The percent erasability is calculated by multiplying Eₜₒₜ by 100.

The intensity of the marking can be determined by recording the reflectance of the marking (“Reflectance of Marking”) and calculating the difference between the Blank Reflectance and the Reflectance of Marking. The percent intensity of the marking is calculated by normalizing the calculated intensity difference to the Blank Reflectance and multiplying this value by 100. A black standard has an intensity of marking equal to 100%.

Line uniformity of a marking can be determined by calculating the intensity of the marking at several different portions of the marking and determining the standard deviation of the intensity of the marking based upon the measured intensities. Line uniformity is inversely proportional to the standard deviation of the intensity, i.e., a lower standard deviation of the intensity corresponds to a higher line uniformity.

The invention can be better understood in light of the following examples which are intended as an illustration of the practice of the invention and are not meant to limit the scope of the invention in any way.

### EXAMPLES

The invention will be further illustrated by way of the following non-limiting examples.

Formulations for Erasable Platy-Like Containing Inks

Samples were formulated in small quantities of 10-20 mL according to the component weight percentages listed in Table 1. The mixing procedure was performed by first combining all organic ingredients and water except the pigment in a 50 mL glass vial fitted with magnetic stirrer. The vial was capped and placed on a magnetic stirrer plate. After homogenous/transparent solution was obtained pigment was then introduced.

Magnetic stirring was resumed when only graphite was used; however, when platy pigment from EMD Chemicals Inc. was used magnetic stirrer was removed and the jar was rolled on rollers for an hour.

In the formulations set forth in Table 1, the pearlescent pigments (EMD Chemicals Inc., Hawthorne, N.Y.; and Rona business unit of EMD Chemicals Inc.) and the pigment was used as received. The graphite platy was Micro790, A146, 3243, (Asbury Graphite Mills, Asbury, N.J.). The lubricious particles were Microslip 519 micronized polytetrafluoroethylene powder (Presperse, Inc., Piscataway, N.J.) with a mean particle size of 5.0 6.0 microns. The dispersants and wetting agents were Disperbyk D-192 and BYK-345 (BYK-Chemie USA, Wallingford, Conn.) and Emerest 2646 (Cognis Corporation, Cincinnati, Ohio), the preservative was Proxel GXL (19.3% by weight solution in dipropylene glycol and water from Avecia Biocides, Wilmington, Del.), the humectant ethylene glycol (Fisher Scientific Company, Pittsburgh, Pa.), and the water was HPLC grade deionized water.

TABLE 1

| | Example ID | | | | | | | | |
|---|---|---|---|---|---|---|---|---|---|
| | | | | | | | | Comparative | Comparative |
| Components | 1 parts | 2 parts | 3 parts | 4 parts | 5 parts | 6 parts | 7 parts | example | example |
| Micro 790 | 0.4 | | | 1.0 | | | | | |
| 146 | | 2.0 | | | | 1.0 | | | |
| 3243 | | | | | 1.0 | | | | |
| MicaBlack | | | | | | | 2.0 | 2.0 | 2.0 |
| BlackStar blue | 1.6 | | 2.0 | | | | | | |
| Dysperbyk 192 | 0.05 | 0.05 | 0.05 | 0.05 | 0.05 | 0.05 | 0.05 | 0.05 | 0.05 |
| BYK 345 | 0.05 | 0.05 | 0.05 | 0.05 | 0.05 | 0.05 | 0.05 | 0.05 | 0.05 |
| EMEREST 2646 | 0.05 | 0.05 | 0.05 | 0.05 | 0.05 | 0.05 | 0.05 | 0.05 | 0.05 |
| Microslip 519 | | | 0.5 | | | | | | |
| sucrose | | | 2.0 | 1.0 | | | | | |
| Joncryl 60 | | | | | 1.0 | 1.0 | | | |
| Kelzan ST | | | | | | | | 0.02 | |
| Xanthan gum | | | | | | | | | 0.02 |
| Ethylene glycol | 2.4 | 2.4 | 1.5 | 1.4 | 1.5 | 1.5 | 2.52 | 2.4 | 2.4 |
| Water HPLC | 5.6 | 5.6 | 5.6 | 5.6 | 5.6 | 5.6 | 5.33 | 5.6 | 5.6 |
| grade | | | | | | | | | |
| Laydown H M L | H | H | M | H | L | H | H | None | None |
| erasability | Poor | Poor | good | Poor | Poor | Poor | Average | n/a | n/Fa |
| smudge | Y/high | N/low | N/low | Y/ | N/low | N/low | Y/high | n/a | n/a |
| Y/N | | | | medium | | | | | |
| Drying time | average | average | fast | fast | average | average | average | n/a | n/a |

The comparative examples are based on shear thinning inks which do not pass through the porous nib as compared to the non shear thinning inks.

Although the present invention has been described hereinabove by way of non-restrictive illustrative embodiments thereof, it can be modified, without departing from the spirit, scope and nature of the subject invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claims is:

1. A water-based erasable marker ink comprising:
an aqueous vehicle;
a film former in said aqueous vehicle; and
a colorant in said aqueous vehicle said colorant comprising platy-like pigment particles.

2. The water-based erasable marker ink according to claim 1 wherein said colorant exhibits a non-neutral color.

3. The water-based erasable marker ink according to claim 1 wherein said aqueous vehicle is non shear thinning.

4. The water-based erasable marker ink according to claim 1 wherein said colorant consists essentially of said platy-like pigment particles.

5. The water-based erasable marker ink according to claim 1 wherein said colorant contains said platy-like pigment particles.

6. The water-based erasable marker ink according to claim 1 wherein said colorant is essentially free of colorants other than said platy-like pigment particles.

7. The water-based erasable marker ink according to claim 1 wherein said platy-like pigment particles have an average thickness of less than 3.0 microns.

8. The water-based erasable marker ink according to claim 1 wherein said platy-like pigment particles have an average thickness of less than 1.0 micron.

9. The water-based erasable marker ink according to claim 1 wherein said platy-like pigment particles have an average thickness of less than 0.25 microns.

10. The water-based erasable marker ink according to claim 1 comprising from 3 weight percent to 25 weight percent of the platy-like pigment particles and from 60 weight percent to 96 weight percent of the aqueous vehicle.

11. The water-based erasable marker ink according to claim 1 comprising from 5 weight percent to 20 weight percent of the platy-like pigment particles, and from 74 weight percent to 94 weight percent of the aqueous vehicle.

12. The water-based erasable marker ink according to claim 1, wherein said said platy-like pigment particles have an average diameter from about 1 micron to about 75 microns.

13. The water-based erasable marker ink according to claim 1, wherein said film former is selected from the group consisting of acrylic copolymers, mono and di-saccharides.

14. The water-based erasable marker ink according to claim 1, wherein said ink exhibits an erasability of at least about 80%.

15. The water-based erasable marker ink according to claim 1 wherein said platy-like pigment particles have an average aspect ratio from 1:1 to 1:8.

16. The water-based erasable marker ink according to claim 15 wherein said average aspect ratio is less than 1:5.

17. The water-based erasable marker ink according to claim 15 wherein said average aspect ratio is less than 1:3.

18. The water-based erasable marker ink according to claim 15 wherein said average aspect ratio is less than 1:2.

19. The water-based erasable marker ink according to claim 1, wherein said platy-like pigment comprises graphite.

20. The water-based erasable marker ink according to claim 1, wherein said platy-like pigment particles comprise metal flake pigments.

21. The water-based erasable marker ink according to claim 1 wherein said platy-like pigment particles comprise glass.

22. The water-based erasable marker ink according to claim 21 wherein said platy-like pigment particles comprise metal-coated glass particles.

23. The water-based erasable marker ink according to claim 1 wherein said platy-like pigment particles comprise pearlescent particles.

24. The water-based erasable marker ink according to claim 23 wherein said pearlescent particles comprise a coating comprising a material selected from the group consisting of: Fe₂O₃, Fe₃O₄, chromic oxide (Cr₂O₃), cobalt titanate (CoTiO₃), aluminum oxide, silica, ferric ferrocyanide, iron blue, carmine, and D&C Red 30.

25. The water-based erasable marker ink according to claim 23 wherein said colorant comprises a black pigment.

26. The water-based erasable marker ink according to claim 23 wherein said pearlescent particles comprise particles selected from the group consisting of pearl essence, basic lead carbonate, lead hydrogen arsenate and bismuth oxychloride.

27. The water-based erasable marker ink according to claim 23 wherein said pearlescent particles comprise mica flake pigments.

28. The water-based erasable marker ink according to claim 27 wherein said mica flake pigments comprise a mica selected from the group consisting of: Mica Black, silica/mica, iron oxide/mica, ferric ferrocyanide/mica and titanium dioxide/mica.

29. The water-based erasable marker ink according to claim 27 wherein said mica flake pigments comprise a metal oxide coating.

30. The water-based erasable marker ink according to claim 29 wherein said mica flake pigments comprise Illite and said metal oxide coating comprises of a metal oxide selected from the group consisting of: titanium dioxide, chromium oxide, cobalt oxide, nickel oxide, tin oxide and iron oxide.

31. A water-based erasable marker ink according to claim 1, wherein said aqueous vehicle comprises a dispersant, water and a humectant.

32. The water-based erasable marker ink according to claim 31, wherein said humectant is selected from the group consisting of glycols, glycerol and long chain alcohols.

33. The water-based erasable marker ink according to claim 31, wherein said dispersant is a surfactant.

34. The water-based erasable marker ink according to claim 31 further comprising lubricious particles suspended in said aqueous vehicle.

35. The water-based erasable marker ink according to claim 34, wherein said lubricious particles comprise powdered PTFE.

36. The water-based erasable marker ink according to claim 34, wherein said lubricious particles comprise aromatic polyesters.

37. The water-based erasable marker ink according to claim 31, wherein said aqueous vehicle further comprises an anti-microbial preservative.

38. The water-based erasable marker ink according to claim 37, wherein said aqueous vehicle comprises 0-0.5% by weight of said anti-microbial preservative.

39. A writing instrument comprising:
a reservoir holding a water based erasable ink comprising platy-like pigment particles and film formers dispersed in an aqueous vehicle.

40. A writing instrument according to claim 39, further comprising a stamping element in fluid communication with said reservoir for stamping said water based erasable ink on a substrate.

41. A writing instrument according to claim 40, wherein said stamping element comprises a flattened nib.

42. A writing instrument according to claim 39, further comprising a nib in fluid communication with said reservoir.

43. A writing instrument comprising:
a reservoir holding a water based erasable ink having a non-shear-thinning composition; and
a porous fiber nib in fluid communication with said reservoir.

44. The writing instrument according to claim 43, wherein said porous fiber nib comprises fiber bundles aligned in an ink flow direction.

45. The writing instrument according to claim 43 wherein said porous fiber nib comprises a sponge like material.

46. A method of forming an erasable marking on a paper substrate comprising:
making a marking on the paper substrate with a writing instrument that includes a water based erasable ink comprising platy-like pigment particles and film formers dispersed in an aqueous vehicle.

47. A method of forming an erasable marking on a paper substrate comprising:
making a marking on the paper substrate with a writing instrument that includes a water based erasable ink having a non-shear-thinning composition, and having a porous fiber nib for delivering said ink to the paper substrate
